(19) United States
(12) Patent Application Publication
(10) Pub. No.: US 2021/0353981 A1
(43) Pub. Date: Nov. 18, 2021

(54) WASHABLE HIGH EFFICIENCY RESPIRATOR MASK

(71) Applicant: Standard Fiber, LLC, Burlingame, CA (US)

(72) Inventors: W. Alexander Gray, III, Whitefish, MT (US); Jing Lou, San Francisco, CA (US)

(21) Appl. No.: 17/323,035

(22) Filed: May 18, 2021

Related U.S. Application Data
(60) Provisional application No. 63/026,504, filed on May 18, 2020.

(51) Int. Cl. A62B 23/02; A41D 13/11; B01D 39/16; A62B 18/08

(52) U.S. Cl. CPC A62B 23/025; A41D 13/1192; B01D 39/1692; B01D 2239/0609; B01D 2239/0622; B01D 2239/0442; B01D 2239/0613; A62B 18/084

(57) ABSTRACT

A washable, high efficiency mask has a first, inner layer, a second, intermediate layer, and a third, outer layer. The second, intermediate layer is a filter media that achieves the 95% particulate filtration efficiency (PFE)/bacterial filtration efficiency (BFE) filtration. The second, intermediate layer is bonded to a layer adjacent thereto.

### CROSS-REFERENCE TO RELATED APPLICATION DATA

This application claims the benefit of and priority to Provisional U.S. Patent Application Ser. No. 63/026,504, filed May 18, 2020, titled “Washable High Efficiency Respirator Mask,” the disclosure of which is incorporated herein in its entirety.

### BACKGROUND

Many types of respirators are available for different uses. For example, respirators are available that provide air filtration to persons in contaminated or hazardous breathing environments, such as medical personnel and medical patients. Masks can also be used by infected individuals to protect others from becoming infected by the spread of viruses and the like through airborne or droplet spread.

Due to the recent novel corona virus pandemic, there have been widespread shortages of personal protective equipment (PPE) such as masks, gowns, coveralls and gloves for medical personnel, as well as others determined to be essential workers. As a result, such PPE, and specifically respiratory masks are in high demand and short supply. And, given the current situation that may require individuals to wear masks when in public spaces or when, for example, shopping, the demand for masks will likely only grow.

There are many types of masks that are currently available. Molded fiber masks or conventionally recognized N95 or KN95 respirators are designed to achieve a very close facial fit and very efficient filtration of airborne particles.

The ‘N95’ designation means that when subjected to careful testing, the respirator blocks at least 9.5 percent of very small (0.3 micron) test particles. When properly fitted, the filtration capabilities of N95 respirators exceed those of face masks. These masks are tested for fluid resistance, filtration efficiency (particulate filtration efficiency and bacterial filtration efficiency), flammability and biocompatibility. It is advised that these masks should not be shared or reused.

N95 respirators are labeled as “single-use,” disposable devices. If your respirator is damaged or soiled, or if breathing becomes difficult, you should remove the respirator, discard it properly, and replace it with a new one.

The single use designation of such respirators is a significant drawback to the currently available N95 and KN95 respirator masks. Not only does single use create issues with lack of available supply, but it also creates unnecessary waste that requires disposal in a landfill or other waste storage facility.

Homemade masks are also in widespread use. Often such masks can be reused, by washing, for multiple uses. It is thought the washing eliminates the likelihood of retaining contaminants. Typically, these masks include a one-layer or two-layer construction. Some two-layer masks include pockets between the layers in which a fitter material can be positioned to increase the filtering capabilities of the mask.

Common household materials, such as cotton materials, synthetics and the like are used for such home made masks. Filter materials when used are often taken from high-efficiency particulate air (HEPA) filters, for example, home air filters. These materials, typically, a melt blown polypropylene material that achieves the 95% particulate filtration efficiency (PFE)/bacterial filtration efficiency (BFE) filtration in surgical style, N95 and KN95 masks are recognized for their air filtration capabilities, but they cannot be washed and as such are not reusable. That is, like the known N95 and KN95 respirator masks the filter material must be disposed of after a period of use.

Moreover, many of these masks do not provide protection for the user; rather, they only provide protection from the user spreading to others, and protection from the user spreading to him/herself by touching his/her face

Nevertheless, while these masks, and particularly those in which a filter material can be used, appear to function fairly well, the masks must be disassembled, e.g., the filter material removed and discarded, in order to clean the mask, i.e., prior to washing. That is, the challenge with the melt blown polypropylene filtration media in disposable masks is that the material cannot be washed and reused and still maintain it's 95% filtration performance.

Accordingly, there is a need for a mask formed from materials having the filtering capabilities of N95 or KN95 that can be reused. Desirably, such as mask can be cleaned, for example, by washing. Desirably, such as mask can be washed “as-is” without disassembly.

### BRIEF SUMMARY

Various embodiments of a washable, high efficiency mask, include a first, inner layer, a second, intermediate layer, and a third, outer layer. The second, intermediate layer is a filter media that achieves the 95% particulate filtration efficiency (PFE)/bacterial filtration efficiency (BFE) filtration.

The second, intermediate layer is bonded to a layer adjacent thereto. In embodiments, the filter media is permanently bonded to a layer adjacent thereto. In embodiments, the filter media is polypropylene or polyurethane material. The polypropylene material can be a melt blown polypropylene or the polyurethane material can be a breathable micro or nano-pore polyurethane film.

In an embodiment having a 3-layer material, the intermediate layer can be bonded to the first, inner layer. In the 3-layer embodiment, the intermediate layer can be bonded to the third, outer layer. In the 3-layer the intermediate layer can be bonded to both the first, inner layer and the third, outer layer.

One or both of the inner and outer layers can be formed from a washable woven, knit, cotton or polymeric material. One or both of the inner and outer layer can include an antimicrobial or an antiviral.

In embodiments, the mask includes an upper portion and a lower portion. The upper and lower portions can be pleated to define a middle portion of the mask. The middle portion of the mask can be opened such that the pleats form a cup-like pocket in the mask. The pleats can unfold to extend over a user's nose and under the user's chin.

The mask can further include securing elements to secure the mask to a user's face. The securing elements can be loops, such as elastic loops that are configured to loop over a user's ears, loops such as elastic loops that go around the back of the user's head (e.g., to encircle the user's head) and can also be strips or straps that tie at the back of the user's head.

Other aspects, objectives and advantages will become more apparent from the following detailed description when taken in conjunction with the accompanying drawings.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a front or outside view of an embodiment of a washable, high efficiency respirator mask;

FIG. 2 is a rear or inside view of the mask of FIG. 1;

FIG. 3 is a side view of the mask folded in half;

FIG. 4 is a front or outside view of another embodiment of a washable, high efficiency respirator mask;

FIG. 5 is a rear or inside view of the mask of FIG. 4;

FIG. 6 is an illustration of the mask on a user; and

FIG. 7 is an exploded view of the mask showing the 3-ply or 3-layer construction.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated.

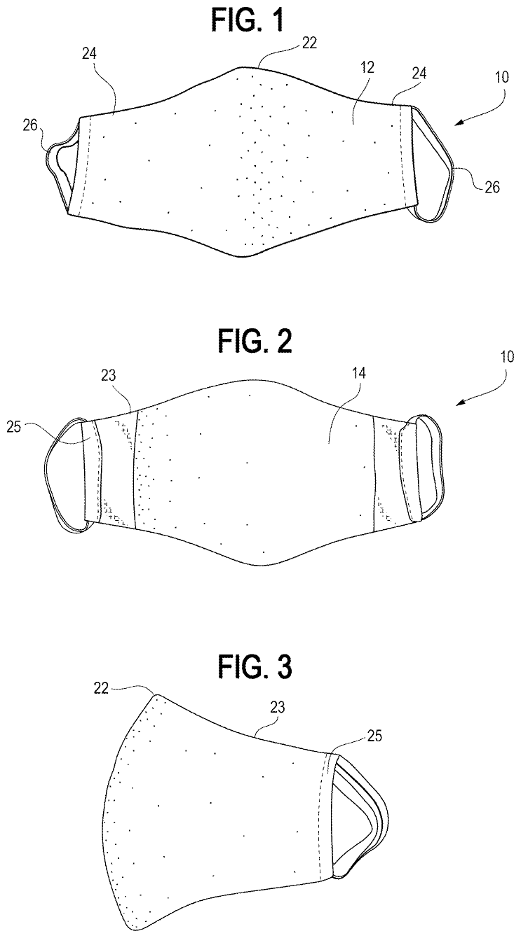

Referring now to the figures, FIGS. 1-3 there is shown an embodiment of a washable, high efficiency respirator mask 10. FIG. 1 illustrates a front or outside 12 of the mask 10, FIG. 2 illustrates the rear or inside 14 of the mask 10, and FIG. 3 shows the mask 10 folded over. The mask 10 is formed from a multi-layered material 11, and in embodiments, includes an inner material layer 16, an outer material layer 18 and, as shown in the exploded view of FIG. 7, an intermediate or middle material layer 20.

In embodiments, the mask 10 includes an enlarged central region 22 that extends from about above a user's nose to at or below the user's chin. The sides 24 of the mask 10 then taper inward as at 23 as they extend over the user's cheeks and include attachment elements 26, such as elastic bands affixed to the ends 28 of the sides 24 to loop over the user's ears to secure the mask 10 in place on the user's face. The attachment elements can be elastic bands affixed to the ends 28 of the sides 24 to loop around the back of the user's head (e.g., to encircle the user's head) to secure the mask 10 in place on the user's face, and the attachment elements can be strips or straps (not shown) that are fitted around the back of a user's head and, for example, tie at the back of the head to secure the mask to the user's face.

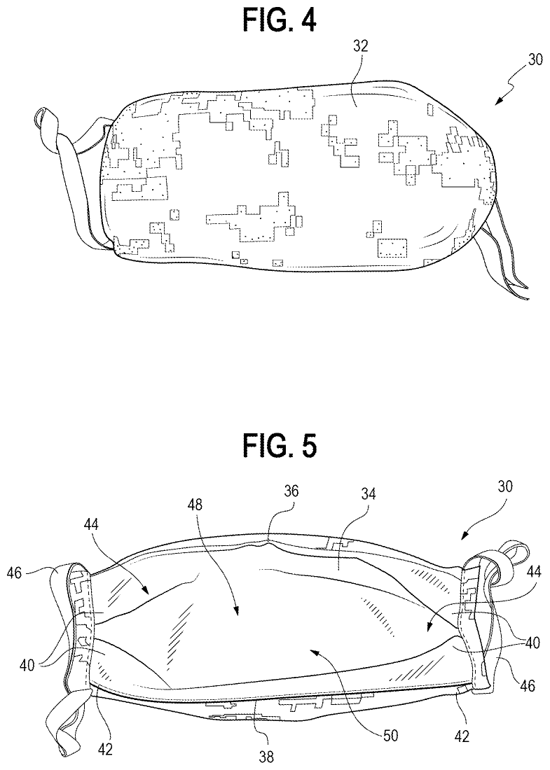

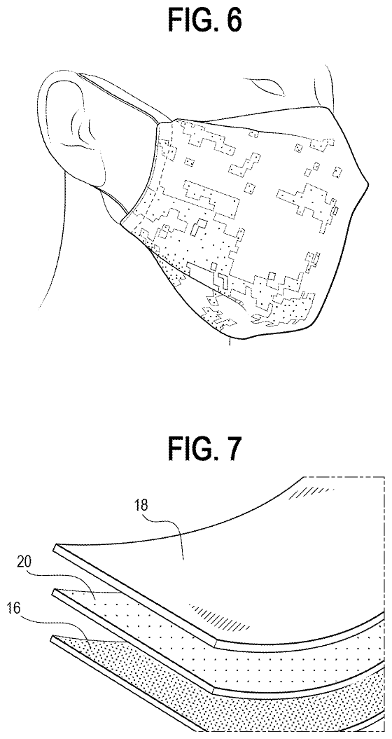

FIGS. 4-6 illustrate another embodiment 30 of a washable, high efficiency respirator mask, in which FIG. 4 illustrates a front or outside 32 of the mask 30, FIG. 5 illustrates the rear or inside 34 of the mask 30, and FIG. 6 illustrates the mask 30 as worn by a user. Similar to the embodiment of FIGS. 1-3, this embodiment of the mask 30 is formed from the multi-layered material 11, and in embodiments, includes the inner material layer 16, the outer material layer 18 and again, as shown in the exploded view of FIG. 7, the intermediate or middle material layer 20.

This embodiment 30 includes upper and lower portions 36, 38, respectively, of the multi-layered material 11 that are pleated, as indicated at 40, and stitched to ends 42 of the mask 30 to form a fold, as indicated at 44. Attachment elements 46, such as the illustrated elastic bands are stitched to the ends 42 of the mask 30, or are positioned in pockets (not shown) at the ends 42 of the mask 30 to receive the bands 46 to loop over the user's ears to secure the mask 30 in place on the user's face. The attachment elements can also be elastic bands affixed to the ends 28 of the sides 24 to loop around the back of the user's head (e.g., to encircle the user's head) to secure the mask 10 in place on the user's face, and, as with the prior embodiment, the attachment elements may include strips or straps (not shown) that are fitted around and tie at the back of the user's head to secure the mask to the user's face.

A middle portion, as indicated at 48, of the mask 30 can be opened or unfolded such that the pleats 40 form a cup-like pocket 50 in the mask 30 to effectively cover the user's face from the chin, up to and over the user's nose, as shown in FIG. 6. The pleats 40 allow for unfolding the mask 30 material to extend over the user's nose and under the user's chin.

Referring now to FIG. 7, there is shown an exploded view of the construction of the multi-layered material 11 used in the washable, high efficiency respirator mask 10, 30. The first or inner layer 16 can be any of a wide variety of materials. The inner layer 16 material is a washable material, such as a woven, knit, cotton or polymeric material, such as a polyester. Optionally, an antimicrobial or anti-virus treatment can be applied to the inner layer 16 material to further the protective characteristics of the material.

The second or outer layer 18 can be similar to the inner layer 16 and as such, can also be any of a wide variety of materials. The outer layer 18 material is also a washable material, such as a woven, knit, cotton or polymeric material, such as a polyester. A skin-compatible antimicrobial or anti-virus treatment can also be applied to the outer layer 18 material to further the protective characteristics of the material.

The middle layer 20 material is a filter media. It is contemplated that the filter material is a melt blown polypropylene (PP) or polyurethane (PU) film material that achieves the 95% particulate filtration efficiency (PFE)/bacterial filtration efficiency (BFE) filtration of surgical style, N95 and KN95 masks, which materials are recognized for their air filtration capabilities. One suitable PU film is a breathable micro or nano-pore PU film.

In order to provide the washability of the washable, high efficiency respirator mask 10, 30 the middle layer 20 is bonded to one or both of the layers adjacent to it. In embodiments, the middle layer 20 is permanently bonded to one or both of the layers adjacent to it. In the illustrated 3-layer construction, the middle layer 20 is bonded to one or both of the inner and outer layers 16, 18, respectively. The bonding can be accomplished by any of a number of bonding methods, such as ultrasonic bonding, heat bonding, adhesives and the like. However, the bonding method used should be compatible with the materials being bonded and should not significantly affect the filtration characteristics of the filtration material (the middle layer 20), nor should it significantly affect the breathability of the multi-layered construction 11 or the mask 10, 30.

It has been found that the present washable, high efficiency respirator mask can be washed at at least 60° C. (140° F.) to kill the novel Corona virus (SARS-CoV-2) in accordance with the recommendations outlined by the World Health Organization (WHO) and maintain its effectiveness of achieving at least a 95% particulate filtration efficiency (PFE), and has been measured to achieve a 97% PFE.

It is contemplated that additional layers can be added to the multi-layered construction 11 to provide additional desired characteristics. In addition, although not shown, a malleable strip, such as a metal strip can be included in the mask 10, 30, as about the location that corresponds to a user's nose bridge, to conform the mask 10, 30 to the user's facial characteristics and provide a tighter fit over the user's nose.

It will be appreciated that the construction and materials of the present washable, high efficiency respirator mask 10, 30 provide a mask that can replicate/exceed the performance characteristics of disposable medical grade masks (e.g., N95 and KN95), and provide protection for the user, as well as individuals in proximity to the user. Such a washable, high efficiency respirator mask 10, 30 addresses the challenges posed with filtration media in disposable masks to achieve at least the 95% PFE/BFE filtration of surgical style, N95 and KN95 masks that cannot be washed and reused and still maintain at least 95% filtration performance.

The words “a” or “an” are to be taken to include both the singular and the plural. Conversely, any reference to plural items shall, where appropriate, include the singular. All patents and published application referred to in this disclosure are incorporated herein in their entirely whether or not expressly done so herein. It will be appreciated by those skilled in the art that the relative directional terms such as upper, lower, rearward, forward and the like are for explanatory purposes only and are not intended to limit the scope of the disclosure.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A washable, high efficiency mask, comprising:
a first, inner layer,
a second, intermediate layer; and
a third, outer layer,
wherein the second, intermediate layer is a filter media,
wherein the filter material achieves a 95% particulate filtration efficiency (PFE)/bacterial filtration efficiency (BFE) filtration, and
wherein the second, intermediate layer is bonded to a layer adjacent to the second, intermediate layer.

2. The mask of claim 1, wherein the filter media is polypropylene or polyurethane material.

3. The mask of claim 2, wherein the polypropylene or polyurethane material is a melt blown polypropylene material or a polyurethane film material.

4. The mask of claim 3, wherein the polyurethane film material is a breathable micro or nano-pore PU film.

5. The mask of claim 1, wherein the second, intermediate layer is permanently bonded to the layer adjacent thereto.

6. The mask of claim 1, wherein the second, intermediate layer is bonded to the first, inner layer.

7. The mask of claim 1, wherein the second, intermediate layer is bonded to the third, outer layer.

8. The mask of claim 1, wherein one or both of the inner layer and the outer layer is formed from a washable woven, knit, cotton or polymeric material.

9. The mask of claim 1, wherein one or both of the inner layer and the outer layer includes an antimicrobial or an antiviral.

10. The mask of claim 1, wherein the mask includes an upper portion and a lower portion, the upper and lower portions being pleated, and wherein a middle portion of the mask can be opened such that the pleats form a cup-like pocket in the mask

11. The mask of claim 10, wherein the pleats unfold to extend over a user's nose and under the user's chin.

12. The mask of claim 1, further including bands to loop over a user's ears.

13. The mask of claim 1, wherein the mask includes three layers.

14. The mask of claim 1, further including bands to encircle a user's head to secure the mask to the user's face.

15. The mask of claim 1, wherein after the mask is washed at 60° C. (140° F.), the mask with the filter material in place achieves a 95% particulate filtration efficiency (PFE).
